(19) United States
(12) Patent Application Publication
(10) Pub. No.: US 2014/0019569 A1
(43) Pub. Date: Jan. 16, 2014

(54) METHOD TO DETERMINE PATTERNS REPRESENTED IN CLOSED SEQUENCES

(71) Applicants: Amit Vasant Sharma, Pune (IN); Rajesh Satchidanand Kulkarni, Pune (IN); Mukund Babaji Neharkar, Pune (IN)

(72) Inventors: Amit Vasant Sharma, Pune (IN); Rajesh Satchidanand Kulkarni, Pune (IN); Mukund Babaji Neharkar, Pune (IN)

(21) Appl. No.: 13/547,990

(22) Filed: Jul. 12, 2012

(51) Int. Cl. G06F 9/46; G06F 15/16

(52) U.S. Cl. 709/208; 718/101

(57) ABSTRACT

Embodiments herein disclose a process to find patterns represented by closed sequences with temporal ordering in time series data by converting the time series data into transactions. A distributed transaction handling unit continuously finds closed sequences with mutual confidence and lowest possible support thresholds from the data. The transaction handling unit distributes the data to be processed on multiple slave computers and uses data structures to store the statistics of the discovered patterns, which are kept up to date in real time. The transaction handling unit partitions the work into independent tasks so that the overhead of inter process and inter thread communication is kept at minimal. The transaction handling unit creates multiple check-points at user defined time interval or on demand or at the time of shutdown and is capable of using any of the available checkpoints and to be ready to process further data in an incremental manner.

### TECHNICAL FIELD

The embodiments herein relate to Data Mining and, more particularly, to implementing a process to find patterns represented by “closed sequences” with temporal ordering by converting the given time-series data into selective transactions in Data Mining.

### BACKGROUND

Low cost of computing power and ability to collect huge amounts of data has given rise to enhanced automatic analysis of data to be processed, which is referred to as Data Mining. Data Mining is the process of analyzing data from different perspectives and summarizing it into useful information that can be used to increase revenue, cut costs, or both. Data mining is one among the prominent number of analytical methodologies for analyzing data. Data mining allows users to analyze data from many different dimensions or perspectives, categorize it, and summarize the relationships and interesting facts thereby identified.

Data mining finds considerable applications in market basket analysis, which studies the buying behaviors of customers by searching for sets of items that are frequently purchased together. Data mining is extensively used in the retail industry to understand typical buying patterns, in the field of weather forecasting, in the fields of financial predictions and so on. Data mining may be carried out by using suitable data mining algorithms.

A data mining algorithm is a set of calculations that create a data mining model from data. To create a model, the algorithm first analyzes the data provided by the user, looking for specific types of patterns or trends. The algorithm uses results of this analysis to define the optimal parameters for creating the mining model. The parameters are then applied across the entire data set to extract actionable patterns and detailed statistics. Typically, the process of data mining is user controlled through thresholds, support and confidence parameters, or other guides to the data mining process.

Existing systems using the algorithms designed so far have to process all the data from scratch when they are restarted even though some amount of data would have already been processed by then. This imposes a serious limitation on their ability of processing the amount of data, as every restart operation becomes a very expensive operation in terms of time and processing power required to reprocess all the data. Moreover, as the data grows over a period of time, the restart operation becomes more expensive.

Certain existing systems implement an algorithm called BIDE (BI-Directional Extension based frequent closed sequence mining) which is used for mining frequent closed sequences. BIDE adopts a novel sequence closure checking scheme called BI-Directional extension and prunes the search space more deeply compared to previously existing systems by using certain methods such as back span pruning method and the scan skip optimization method. A performance study with both sparse and dense real life data sets has demonstrated that BIDE significantly outperforms other existing algorithms by consuming order(s) of magnitude less memory. BIDE is also linearly scalable in terms of database size. However, the limitations of BIDE are that it does not take into account the nature of certain data such as time series data and resultant transactions. This requires BIDE to be adapted for processing the time series data. Further, BIDE expects only transaction data as input and hence real-time streaming time series data which is not transactional in nature is not suitable for processing by BIDE.

Further, there are other systems that are specifically designed to take care of streaming data but they do not use efficient pruning and sequence growing techniques as used in BIDE. None of the existing systems using algorithms take care of backdated data as all of them are designed for consuming new data with forward dated timestamps (where timestamp of the newly arrived data must be greater than the last processed timestamp). Other systems designed for data mining are usually non parallel and are incapable of processing the data in a highly distributed manner.

### BRIEF DESCRIPTION OF THE FIGURES

The embodiments herein will be better understood from the following detailed description with reference to the drawings, in which:

FIG. 1 illustrates a computing environment implementing the application according to the embodiments disclosed herein;

FIG. 2 is a block diagram which depicts the modules involved in processing of the algorithm according to the embodiments disclosed herein;

FIG. 3 illustrates a chart which indicates transactions over sliding time window according to the embodiments disclosed herein;

FIG. 4 is an exemplary diagram which depicts the ‘Global Data table’ according to the embodiments disclosed herein;

FIG. 5a and FIG. 5b are exemplary diagrams which depict the Global Transaction table and sequence data structure according to the embodiments disclosed herein;

FIG. 6 is an exemplary diagram which depicts the relationship between data structures according to the embodiments disclosed herein;

FIG. 7 is a flow diagram which explains the steps to achieve the highest parallelism according to the embodiments disclosed herein; and

FIG. 8 is a flow diagram, which explains the slave processing of the frequent sequences according to the embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

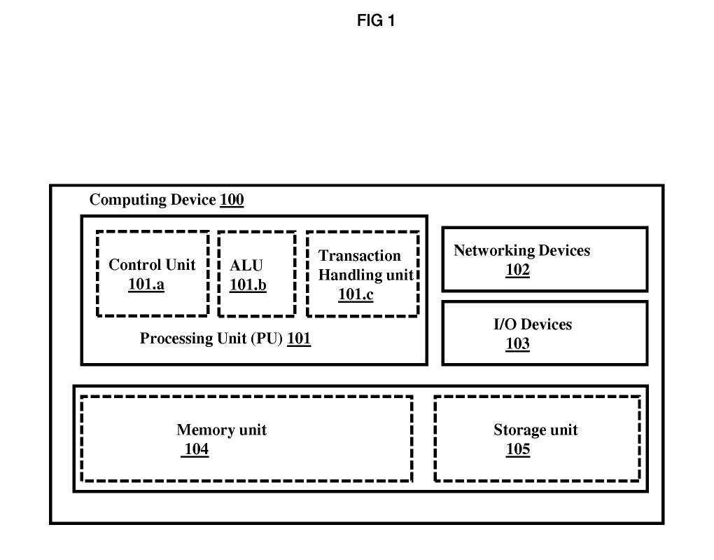

The embodiments herein disclose a method to find patterns represented by closed sequences by converting the time-series data into transactions. Referring now to the drawings, and more particularly to FIGS. 1 through 7, where similar reference characters denote corresponding features consistently throughout the figures, there are shown embodiments.

A process is designed to find patterns represented by closed sequences with temporal ordering in time series data by converting the data into transactions using a sliding time window of chosen length. The process involves working with certain parameters which are defined below:

Time series data (TSD): A set of events (e1, e2 . . . en) with each having its own time stamp (t1, t2, . . . tn) indicating the time of arrival or time at which it has happened, sorted by timestamps such that t1<t2 . . . <tn. For example: TSD={(e1, t1), (e2, t2), (e1, t3), (e2, t3) . . . (en, tn)} Such that t1<t2 . . . <tn.

Time Window: Time window (expressed as a unit of time such as seconds) is a fixed time period within which the events must occur.

Sliding time window: A sliding time window is a time window, which slides over a time series data starting from the first timestamp until last timestamp by one second at a time to cover entire data set.

Transactions over sliding time window: A set of events covered by or have occurred in each sliding time window. For example: TSD={(e1, 1), (e2, 2), (e3, 3), (e4, 4), (e5, 5), (e6, 6) . . . (en, tn)}. Sliding time window of 2 seconds will generate following transactions over sliding time window. T1=(e1, 1), (e2, 2), T2=(e2, 2), (e3, 3), T3=(e3, 3), (e4, 4) . . . Tn−1=(en−1, tn−1), (en, tn), Tn=(en, tn).

A transaction data base (TDB): An ordered collection of transactions over sliding time window. For example: TDB={T1, T2, T3 . . . Tn} where T1, T2 . . . Tn are transactions over sliding time window.

Support: Support is defined as the number of times a sequence of event/s happens with unique timestamps in transactions created using a sliding time window on a time series database.

Support threshold: Support threshold is the minimum support value that a sequence of event(s) must have for it to qualify as Frequent.

Closed sequence: A sequence S={e1; e2; : : : ; en) is not a closed sequence, then there must exist at least an event e0 which can be used to extend sequence S to a new sequence S0 with the support greater than or equal to the Support Threshold. If no such event e0 exists in the transaction database meeting the required support threshold (minimum support), then sequence S is a closed sequence.

Minimum support: Minimum support is the minimum number of times a sequence has to appear in a transaction database in order to qualify to be frequent.

Mutual confidence in temporally ordered sequences: Mutual confidence in temporally ordered sequences is defined as the ratio of number of occurrences of a sequence of length 1 to number of occurrences of its subsequence of length (1−1) when 1>1.

Job: A job is a sequence that needs to be grown further (using BI-Directional extension technique) or pruned (using Back scan pruning technique).

FIG. 1 illustrates a computing environment implementing the application according to the embodiments disclosed herein. The computing device 100 comprises of at least one processing unit 101, networking device 102, I/O device 103, memory 104 and storage unit 105. The processing unit 101 further comprises control unit 101.a, Arithmetic Logic unit (ALU) 101.b and a transaction handling unit 101.c. The processing unit 101 carries out the instructions of a computer program by performing the basic arithmetical, logical, and input/output operations of the system and it receives commands from the control unit 101.a in order to perform its processing.

The transaction handling unit 101.c may use an algorithm to find patterns represented by closed sequences with temporal ordering in time series data by converting the data into transactions. The transaction handling unit 101.c may handle incremental data with future and backdated timestamps. Further, the transaction handling unit may process continuously consuming streaming time series data (When input time series data is provided in a continuous manner, it is called as ‘Streaming time series data’).

In an embodiment, the transaction handling unit 101.c which stores it's data structures in the Memory unit 104, is capable of hibernating or check pointing its state by writing selected data structures from the Memory unit 104 to the Storage unit 105 on the disk which are read back into the main memory unit 104 at the time of start or restart.

In another embodiment the transaction handling unit 101.c may use master—slave server topology or standalone server topology depending on the system requirement to distribute the data to be processed on multiple slave computers using Networking Devices 102 and/or to achieve highest parallelism (parallelize the processing by taking advantage of multiple processing cores) on the same server.

In another embodiment, the transaction handling unit 101.c partitions the work into independent tasks so that the overhead of inter-process and inter-thread communication is kept at minimal.

The overall computing environment can be composed of multiple homogeneous and/or heterogeneous cores, multiple CPUs of different kinds, special media and other accelerators. The processing unit 101 is responsible for processing the instructions of the algorithm. The processing unit 101 receives commands from the control unit in order to perform its processing. Further, any logical and arithmetic operations involved in the execution of the instructions are computed with the help of the ALU 101.b. Further, the plurality of process units may be located on a single chip or over multiple chips.

The algorithm comprising of instructions and codes required for the implementation are stored in either the memory unit 104 or the storage unit 105 or both. At the time of execution, the instructions may be fetched from the corresponding memory 104 and/or storage 105, and executed by the processing unit 101.

In case of any hardware implementations, various networking devices or external I/O devices may be connected to the computing environment to support the implementation through the networking unit and the I/O device unit.

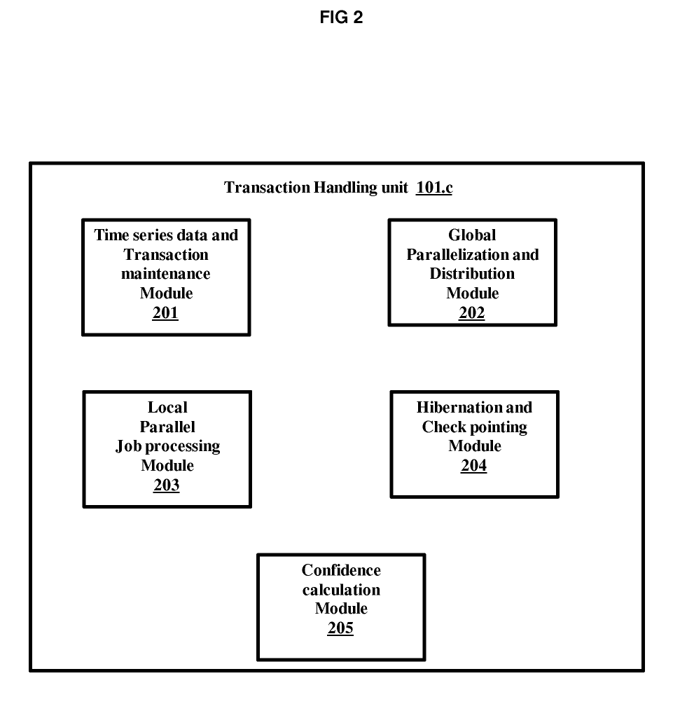

FIG. 2 is a block diagram, which depicts the modules involved in processing of the algorithm according to the embodiments disclosed herein. The transaction handling unit 103 requires certain modules to work in co ordination with the hardware involved, which are the Control unit 101.a, memory 104 and the networking devices 102. The modules, which work in coordination with the transaction handling unit 101.c, are Time series data and transaction maintenance module 201, Global Parallelization and job Distribution Module 202, Local parallel job processing module 203, Hibernation and check pointing module 204 and Confidence calculation module 205.

When created by the Global Parallelization and job Distribution Module 202, ‘a job’ is 1-sequence (a sequence with only 1 event). When received by the Local parallel job processing module 203, it is an n-sequence (where n>=1). In both cases, a job is a sequence that needs to be grown further (using BI-Directional extension technique) or pruned (using Back scan pruning technique).

The time series data and transaction maintenance module 201 is responsible for accepting the time series data and creating the transactions in an incremental manner. In an embodiment, the time series data and transaction maintenance module 201 may also maintain at least one global data structure to store and process the transactions while creating and updating certain other global data structures.

Certain modules involved in the process can reside on either a master server or a slave server, according to system requirement. A master server for a zone is the server that stores the definitive versions of all records in that zone. A slave server for a zone uses an automatic updating mechanism to maintain an identical copy of the master records. Examples of such mechanisms include DNS zone transfers and file transfer protocols. The Global Parallelization and distribution Module 202 resides on the master server, which starts working after “Time series Data and Transaction Maintenance Module 201” has finished its cycle. In an embodiment, the Global Parallelization and distribution Module 202 may distribute the jobs over the network to slaves. A job created by the master is a 1-sequence, which needs to be processed by the slaves. In another embodiment, the global parallelization and distribution module 202 distributes the job to be processed by slaves to either prune it (using back scan pruning technique) or extend it (using bi-direction extension technique).

The local parallel job processing module 203 is the module, which resides in each slave server. The local parallel job processing module 203 receives an input job from Global Parallelization and distribution module 202 of the master and processes the job by recursively dividing it into further jobs and process as many parallel jobs as possible using preconfigured number of threads. In an embodiment the local parallel job processing module 203 may be responsible for pruning the job (using back scan pruning technique) or extending it (using forward and backward extension technique, also called as BI-Directional Extension closure checking in BIDE). Depending on the transaction, the job either is pruned or is extended till it cannot be further grown. The sequence extension and sequence pruning strategies are based on the following theorems and definitions.

Theorem 1 (BI-Directional Extension closure checking):—If there exists no forward-extension event nor backward extension event with respect to a prefix sequence Sp, Sp must be a closed sequence; otherwise, Sp must be non-closed.

Lemma 1 (Forward-extension event checking) for a ‘Prefix Sequence’ Sp, is the complete set of ‘forward-extension’ events is equivalent to the set of its ‘locally frequent’ items whose supports are at least equal to the support threshold

Definition:—First instance of a prefix sequence:—Given an input sequence S which contains a prefix 1-sequence e1, the subsequence from the beginning of S to the first appearance of item e1 in S is called the first instance of prefix 1-sequence e1 in S. Recursively, first instance of a (i+1)-sequence e1, e2, e3 . . . ei can be defined from the first instance of the i-sequence e1, e2, e3 . . . ei (where i>1) as the subsequence from the beginning of S to the first appearance of item ei+1 which also occurs after the first instance of the i-sequence e1, e2, e3 . . . ei. For example, the first instance of the prefix sequence AB, in sequence CAABC—is CAAB.

Definition:—Locally Frequent Items:—Locally Frequent Items are the events items that appear at least minimum support number of times (where minimum support is the support threshold) in the projected databases of the Prefix Sequences.

Definition:—Projected sequence of a prefix sequence: Given an input sequence S that contains a prefix i-sequence e1, e2, . . . ei, the remaining part of S after we remove the first instance of the prefix i-sequence e1, e2, . . . ei, in S is called the projected sequence with respect to Prefix e1, e2 . . . ei, in S. For example, the projected sequence of prefix sequence AB in sequence ABBCA is BCA

Definition:—Project Database of a Prefix Sequence:—Projected Database of a Prefix Sequence is collections of the projected sequence of a prefix sequence from all the transactions where each transaction could be seen as a separate sequence.

Lemma 2 (Backward-extension event checking) Let the prefix sequence be a n-sequence, Sp=e1, e2, . . . en. If 1<=i<=n and there exists an item ‘e’ which appears in each of the ‘i-th maximum periods’ of the prefix Sp in Sequence Data Base, ‘e’ is a backward-extension event (or item) with respect to .prefix Sp. Otherwise, for any i, 1<=i<=n, if it is not possible to find any item which appears in each of the i-th maximum periods of the prefix Sp in Sequence Data Base, there will be no backward-extension with respect to Sp.

Definition:—(The i-th maximum period of a prefix sequence):—For an input sequence S containing a prefix n-sequence Sp=e1, e2, . . . en, the i-th maximum period of the prefix Sp in S is defined as: (1) if 1<i<=n it is the piece of sequence between the end of the first instance of prefix e1, e2, . . . ei−1 in S and the i-th ‘last-in-last appearance’ w.r.t. prefix Sp; (2) if i=1 it is the piece of sequence in S locating before the 1st last-in-last appearance with respect to .Prefix Sp. For example, if S=ABCD, and the prefix sequence Sp=AB, the second maximum period of prefix Sp in S is BC, while the 1st maximum period of prefix Sp is NULL

Definition:—(The i-th last-in-last appearance w.r.t. a prefix sequence) For an input sequence S containing a prefix n-sequence, Sp=e1, e2, . . . en, the i-th last-in-last appearance with respect to the prefix Sp in S is denoted as LLi and defined recursively as: (1) if i==n, it is the last appearance of ei in the ‘last instance of the prefix’ Sp in S; (2) if 1<=i<n, it is the last appearance of ei in the ‘last instance of the prefix’ Sp in S, while LLi must appear before LLi+1. For example, if S=CAABC, and Sp=AB, the 1st last-in-last appearance w.r.t. prefix Sp in S is the second A in S.

Definition:—(Last instance of a prefix sequence) Given an input sequence S which contains a prefix i-sequence e1, e2, ei, the last instance of the prefix sequence e1, e2, . . . ei in S is the subsequence from the beginning of S to the last appearance of item ei in S. For example, the last instance of the prefix sequence AB, in sequence ABBCA is ABB.

Theorem 2:—(BackScan pruning technique):—Let the prefix sequence be an n-sequence, Sp=e1, e2, . . . en, If (1<=i<=n) and there exists an item ‘e’ which appears in each of the ‘i-th semi-maximum periods’ of the prefix Sp in Sequence Data Base, then the process of growing prefix Sp can be stopped.

Definition:—The i-th semi-maximum period of a prefix sequence: For an input sequence S containing a prefix n-sequence Sp=e1, e2, . . . en, the i-th semi-maximum period of the prefix Sp in S is defined as: (1) if 1<i<=n, it is the piece of sequence between the end of the first instance of prefix e1, e2, . . . ei−1 in S and the ‘i-th last-in-first’ appearance with respect to Prefix Sp; (2) if i=1, it is the piece of sequence in S locating before the 1st last-in-first appearance with respect to. Prefix Sp. For example, if S=ABCD and prefix sequence Sp=AC, the 2nd semi-maximum period of prefix AC in S is B while the 1st semi-maximum period of prefix AC in S is NULL

Definition:—The i-th last-in-first appearance with respect to a prefix sequence:—For an input sequence S containing a prefix n-sequence Sp=e1, e2, . . . en, the i-th last-in-first appearance with respect to .the prefix Sp in S is denoted as LFi and defined recursively as: (1) if i=n, it is the last appearance of ei in the first instance of the prefix Sp in S; (2) if 1<=i<n, it is the last appearance of ei in the first instance of the prefix Sp in S while LFi must appear before LFi+1. For example, if S=CAABC and Sp=CA, the 2nd last-in-first appearance with respect to prefix Sp in S is the first A in S. The method used by the transaction handling unit 101.c is theorems 1 and theorem 2 for sequence extension and sequence pruning.

The job is sent to the slave server and the local parallel job processing module 203 within the slave server finds the frequent closed sequences, relevant frequencies of closed sequences and its sub sequences and details of the transactions and time stamps when these sequences were observed. Further, all these details are returned to the master server as the output of the processed jobs. Upon receiving this information, the receiver module at the master server updates a global data structure called “Global Closed Sequence List”.

The hibernation and check pointing module 204 resides on the master server only. In a preferred embodiment the hibernation and check pointing module 204 may be responsible for storing the state of the algorithm by writing certain data structures in a file on disk (such as Global transaction table, global data table, global closed sequence list and configuration options) Further, the set containing the collection of these data structures represent a point of hibernation or check point. Each point of hibernation or checkpoint can be used as a reference database that can be read at the time of restart to restore the state of hibernation or checkpoint. The data structures are read back into the main memory at the time of start (or restart) so that the earlier state of the system is restored quickly. The processing can then continue optimally without having to reprocess any of the already processed data.

The confidence calculation module 205 uses sequence data structure to store closed sequences of variable lengths. The sequence grows with one event at a time if it meets required support threshold. Further, at every stage, discovered sequences are stored and its corresponding support value using the offset in the support array which is equal to the size of the sequence. Thus, at each unique length of the sequence, the support value is stored. In an embodiment, the confidence calculation module 205 reads the closed sequence data structure and support array to find the sequence and its corresponding support. The mutual confidence of each sub-sequence with the sequence is recursively calculated as ratio of support of sequence of length 1 to support of immediate subsequence of length (1-1) till 1>1.

The time series data and transaction maintenance module 201, the global parallelization and distribution module 202, the local parallel job processing module 203, the hibernation and check pointing module 204 and the confidence calculation module 205 are individual modules designed to perform their intended functions but work in synchronization together to achieve a desired output.

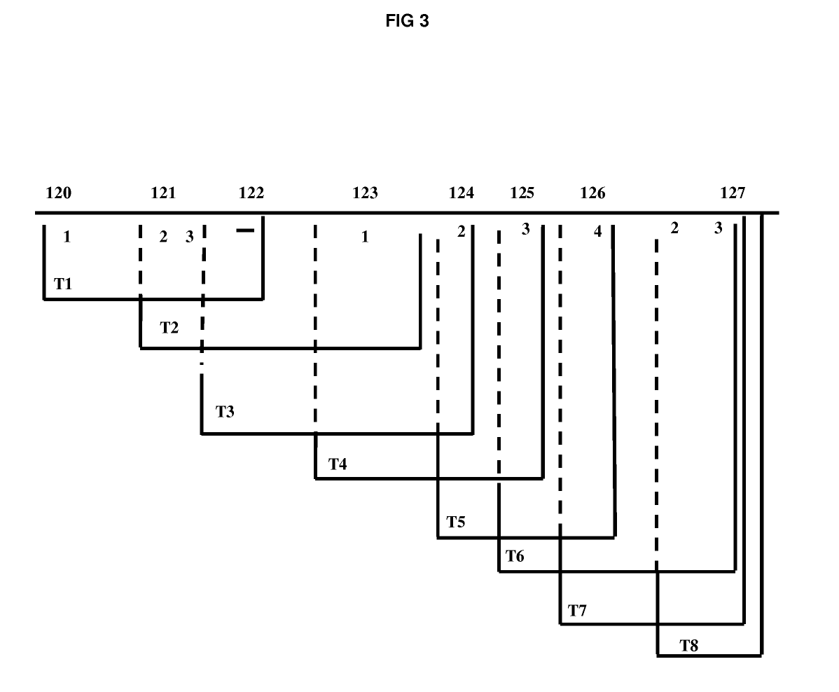

FIG. 3 illustrates a chart, which indicates transactions over sliding time window according to the embodiments disclosed herein. The creation of transactions is explained in the table below. For example consider the time series data as shown below in the table T1:

| | Timestamp | | | | | | | | | |
|---|---|---|---|---|---|---|---|---|---|---|
| | 120 | 121 | 121 | 122 | 123 | 124 | 125 | 126 | 127 | 127 |
| Data point/ | 1 | 2 | 3 | — | 1 | 2 | 3 | 4 | 2 | 3 |
| events, | | | | | | | | | | |

Consider a sliding time window of 3 time units (say seconds) which will create the following transactions according to the table shown below which is table T2.

| | Transaction | Time Stamp and | | |
|---|---|---|---|---|
| Window | ID | Transaction | | |
| 120 to 122 | T1 | 120 | 121 | 122 |
| | | 1 | 2, 3 | — |
| 121 to 123 | T2 | 121 | 122 | 123 |
| | | 2, 3 | — | 1 |
| 122 to 124 | T3 | 122 | 123 | 124 |
| | | — | 1 | 2 |
| 123 to 125 | T4 | 123 | 124 | 125 |
| | | 1 | 2 | 3 |
| 124 to 126 | T5 | 124 | 125 | 126 |
| | | 2 | 3 | 4 |
| 125 to 127 | T6 | 125 | 126 | 127 |
| | | 3 | 4 | 2, 3 |
| 126 to 127 | T7 | 126 | 127 | — |
| | | 4 | 2, 3 | |
| 127 to — | T8 | 127 | — | — |
| | | 2, 3 | — | — |

Considering a support threshold of 2, the following patterns are obtained from the above transactions that meet the minimum support criteria. The patterns are [1], [2], [3], [1, 2], [1, 3], [1, 2, 3] and [2, 3] respectively. For example, the pattern [1] appears at two distinct time stamps, 120 and 123 have actual support of 2 but as the transactions are created over a sliding time window, it has appeared in T1, T2, T3 and T4 transactions. Similarly the pattern [2] appears at three distinct time stamps, 121,124 and 127 respectively which have an actual support of 3 but due to the sliding time window, it has appeared in transactions T1, T2, T3, T4, T5, T6, T7 and T8. Consider the pattern [1,2] which has an actual support of 2 as sequence [1,2] appears only 2 times with a maximum time window of 3 seconds separating them. It appears in transactions T1, T3, T4 but its actual support is 2. This method of representation of patterns is known as inaccurate support calculation due to overlapped transaction.

Further, from table T1, it can be seen that one sequence 1, 2 and 3 appear 2, 3 and 3 time respectively. Similarly, two sequence [1, 2], [2, 3] appears 2 and 3 times respectively and three sequence [1, 2, 3] appears 2 times. Hence [1], [2], [3], [1,2], [2,3] and [1,2,3] qualify to be frequent sequences as all these sequences have a support >=2 which is the support threshold.

The transaction handling unit 101.c is customized to handle transactions created at runtime on the streaming time series data over a sliding time window where the transaction time window can be any user defined value. Further, in an embodiment the transaction handling unit 101.c may be processed over only selected transactions to overcome the effect of inaccurate support calculation due to overlapped transactions and find closed sequences thereby considerably increasing the efficiency of the algorithm by reducing the search space dramatically. Selective transaction processing may be used for pruning and extending the closed sequences.

In another embodiment, the transaction handling unit 101.c may process streaming time series data to find closed sequences in an incremental manner. Further, the transaction handling unit 101.c runs continuously consuming streaming time series data and can process backdated data along with the new data with latest or recent time stamps.

In an embodiment, the transaction handling unit 101.c may be enabled to be highly parallel to utilize preconfigured number of CPU cores on the computer where it runs. The system can be configured to spawn fixed number of threads and hence the CPU consumption can be controlled using simple configuration that can be stored in files, which the transaction handling unit 101.c reads at run time.

In another embodiment, the system may distribute its load on all the available computers in the network utilizing the available CPU (processing power) and memory resources on the network and also theoretically process infinite amount of data.

In another embodiment, the transaction handling unit 101.c may use efficient data structures to store and update the newly discovered patterns, discard obsolete patterns as well as updates the mutual confidence of old patterns in real time. The transaction handling unit 101.c may also use smart data structures to store the statistics of the discovered patterns. The novel data structures are kept up to date in real time with ever changing data that is received in a streaming manner.

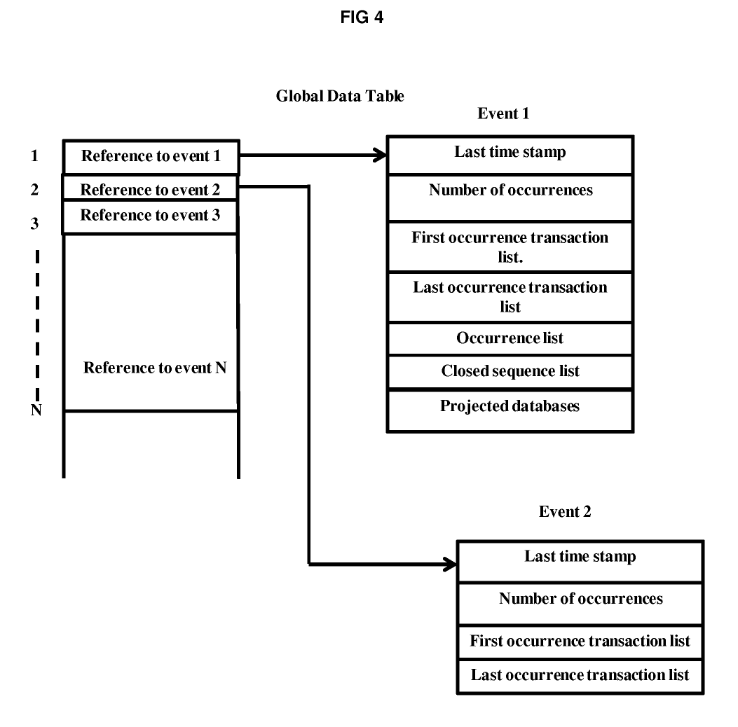

FIG. 4 is an exemplary diagram, which depicts the ‘Global Data table’ according to the embodiments disclosed herein. The ‘Global Data table is a data structure which is used for storing references to the event data structures. The selective transaction processing is a method where for every occurrence of an event; two transactions are noted by recording the transactions IDs in the event data structure. These transactions are called first occurrence transaction and last occurrence transaction respectively. The ‘first occurrence transaction’ is the transaction where an event enters the sliding time window for the first time. The ‘last occurrence transaction’ is the transaction in which event leaves the transaction window. Every unique event is represented by its own instance of the event data structure whose reference is stored in Global data table. In an embodiment, the transaction handling unit 101.c is run on the transaction database by iterating global data table. For each event from global data table that meets the support threshold, the first occurrence transaction list is used for the ‘back scan pruning’ technique and ‘backward extension check’ whereas last occurrence transaction list is used for creating projected databases used in ‘BI-directional extension’ technique which reduces process's runtime by magnitude of times approximately equal to the length of the sliding time window. Further, as the projected databases are created only on Last occurrence transaction, the inaccurate support calculation due to overlapped transaction are avoided thereby deriving exact support values for the patterns discovered.

In an embodiment, the transaction handling unit 101.c can perform incremental processing. Incremental processing is method to progressively search for and filter through the given data so that only limited data is processed. The transaction handling unit 101.c can perform incremental processing of the streaming time series data where it is capable of handling two scenarios such as:
1. Data insertions: When streaming input data has a timestamp (Ti) greater than or equal to the first timestamp (Tf) and less than or equal to the last timestamp (T1) of the already processed data. Tf<=Ti<=T1
2. Data Appends: When streaming input data has a timestamp (Ti) greater than or equal to the last timestamp (T1) of the already processed data. Ti>=T1.

To handle data insertions and data appends, initially an array is pre allocated for certain number of days. The number of days is a configurable variable and can be accepted as an input. This global array is called as global transaction table. Since each day has 86400 seconds and each second may have one or more than one or zero events happening which indicates that there can be one transaction starting at each second of the day provided there exists one or more events at that second of the day.

Further, each day is allocated to hold 86400 slots (with slot size equal to 16 bytes) where each slot is used to hold a transaction ID indicating the start time of the transaction. When an event is received at a particular time stamp, the pre allocated slot in the global transaction table is marked with offset indicating the time stamp of that event. If there is no event at a particular second, the slot in the global transaction table is left empty by marking it to zero. The first event received is taken as the reference point and the timestamps of all the events received after that is used as offsets or considered as offset transactions.

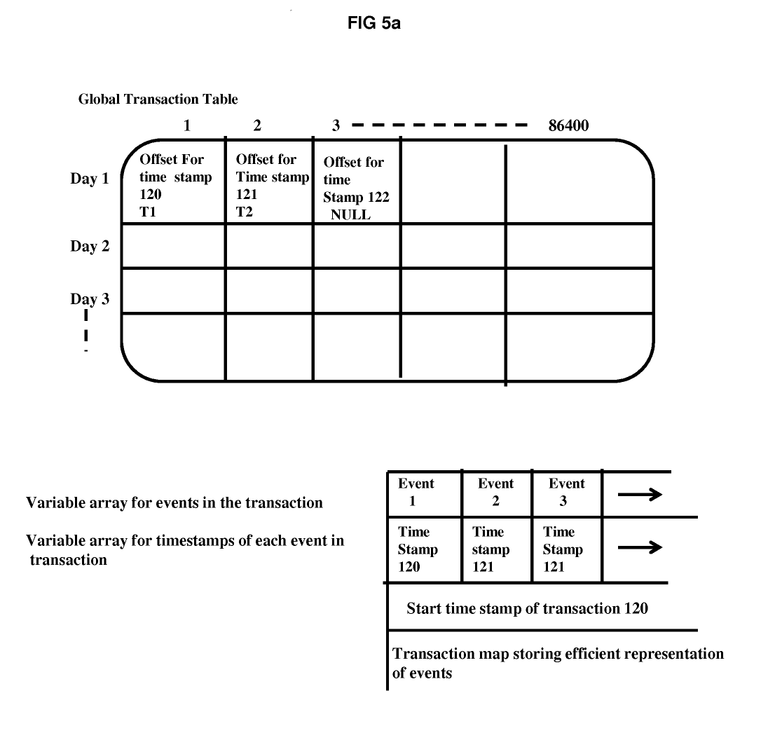

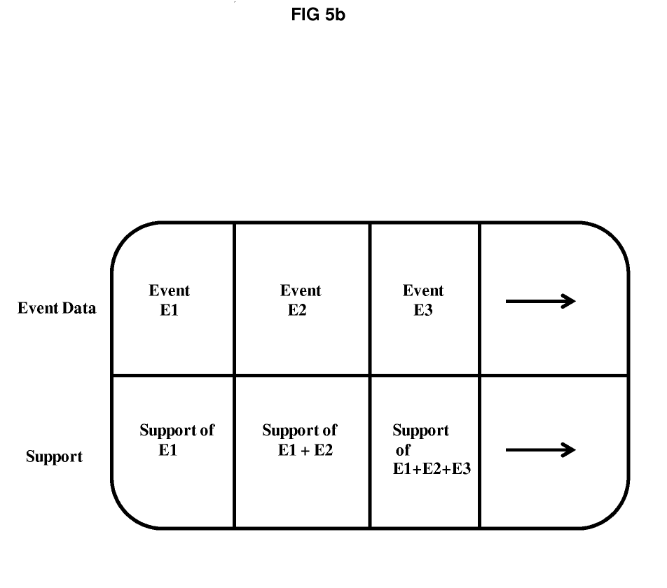

FIG. 5a and FIG. 5b are exemplary diagrams, which depict the Global Transaction table and sequence data structure according to the embodiments disclosed herein. The transaction handling unit 101.c can find affected transactions due to new incoming streaming time series data. When a new event is received, its timestamp is checked first and the offset is computed in the global transaction table. To find the offset, it must be checked whether there is an existing transaction at that slot. At this point two scenarios arise.
1. Scenario 1: At this point, if a transaction Tₓ is found at the slot, the transaction is retrieved using the transaction ID and the new event in that transaction is inserted. Tₓ is called the Last occurrence transaction for the new event, which signifies that no other transaction ahead of this transaction will be affected because of the new incoming event. However, it is necessary to traverse backwards and modify w−1 (where w is the length of sliding time window) transaction before the transaction Tₓ and insert the new incoming event at appropriate locations in those transactions and mark those transactions as affected.
2. Scenario 2: In case there is no transaction, Tₓ found at the slot, it is concluded that the new event is the first event with such time stamp. Hence, it is essential to create a new transaction Tₓ where the new event will be the first event followed by all the events in the event database with timestamp less than or equal to window size plus timestamp of this new event. Further, Tₓ is the last occurrence transaction for the new event. However, it is necessary to traverse backwards and modify w−1 (where w is the length of sliding time window) transactions before the transaction Tₓ and insert the new incoming events at appropriate location in those transactions and mark those transactions as affected.

The affected transactions are identified and the transaction handling unit 101.c performs the following functions:
Impact on support of all existing events from the affected transactions is determined and deducted from the global data table.
If an existing event from the affected transactions is the first event in closed sequence patterns, then such closed sequences are erased which will ensure that reprocessing of such events will give correct and updated closed sequences.
Reprocess the affected transactions.

The discovered closed sequences are stored in global data structure called global closed sequence list and the incremental processing of the streaming time series data is completely achieved and the transaction handling unit 101.c gives real time output by discovering closed sequences with mutual confidence from the input data.

The sequence data structures are used to store closed sequences of variable lengths. Further, the sequence grows with one event at a time if it meets the required support threshold. At every stage, the discovered sequences are stored along with its corresponding support value using the offset in the support array, which is equal to the size of the sequence. The sequence data structure assists in speedy calculation of ‘mutual confidence of the temporally ordered sequence’

Consider that in a time series event database a sequence S is discovered (S=1, 2, 3, 4) which has occurred 4 times in the entire database (support=4) within a time window not greater than size of the sliding time window used to create the transactions. 4 denotes the number of occurrences of the sequence S as support and is indicated by supp(s)=4. Further, in this case sequence 1, 2, 3 is followed by 4 for 4 times and hence mutual confidence of S is denoted as M(S)=Supp(s)/Supp(S−1) where S−1 is a sequence created by removing last event from S, also called as predecessor sequence (or immediate sub-sequence) of the event which when removed from the original sequence S of length l, results into a sub sequence of length l−1.

Further, (S−1) in this example is 1, 2, 3. If Supp(S−1)=5, M(S)=4/5=0.8 or 80%. This ratio is a measure of probability of event 4 following sequence 1, 2, 3. Sequence 1, 2, 3 is called as a predecessor sequence of 4. The sequence data structure is used to store closed sequences of variable lengths and the sequence grows with one event at a time if it meets the required support threshold. At every stage, discovered sequences are stored along with its corresponding support value using the offset in the support array, which is equal to the size of the sequence. Therefore, at each unique length of the sequence, the value of its support is stored. By using this technique, if one accesses a closed sequence of length l, its support using an offset of 1 can also be immediately accessed.

The state of the transaction handling unit 101.c processing the algorithm is stored by writing selected data structures on the disk in the binary format. The data structures can be read at the time of restart or at any desired time to restore the exact state of the algorithm at the time of hibernation. Further, the transaction handling unit 103 need not reprocess any of the processed data. The transaction handling unit 103 is ready to start processing new input.

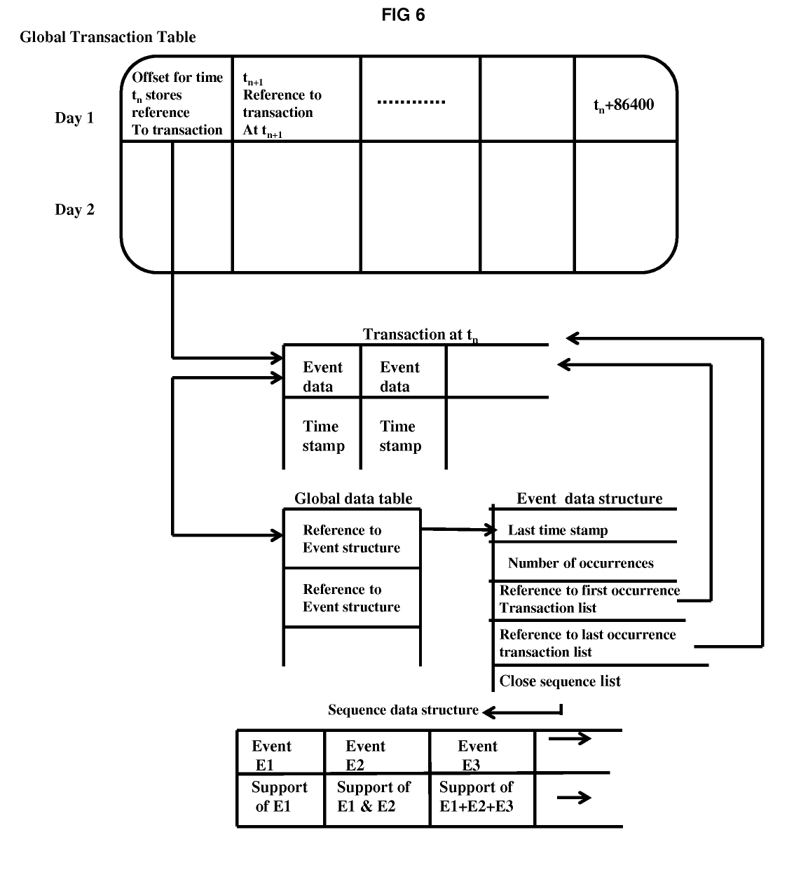

FIG. 6 is an exemplary diagram, which depicts the relationship between data structures according to the embodiments disclosed herein. The transaction handling unit 101.c uses three critical data structures that are required for hibernating and recovering from that point. They are:
Global transaction table: The data structure is a global array used for storing references to the transactions created over the sliding time window. The transaction handling unit 101.c iterates through global transaction table to get all the transactions and to write the following details of transactions on the disk such as transaction ID, transaction size, events or data points in the transactions and their respective time stamps.
Global data table: The global data table stores the reference to the event data structure. Every unique event is represented by its own instance of the event data structure whose reference is stored in global data table. The global data table is iterated and the details of each event data structure are written on the disk in the binary format. The details of events that are stored on the disk are unique event identifier, first occurrence transaction list, last occurrence transaction list, projected databases of each event and closed sequences transaction list.
Global closed sequence list: The closed sequence list maintains the list of closed sequences. The global closed sequence list stores the size of the closed sequence reference to the ordered list of events, maximum support of the sequences indicating the event with highest number of occurrences in the entire database, list of transactions where this sequence has appeared and actual support of the closed sequence. All this information is written on the disk.

Once the three data structures are completely written on the disk, it is considered as a checkpoint or a state of hibernation. This information is sufficient for the transaction handling unit 101.c to regain its state from the time of check pointing. In an embodiment, the transaction handling unit 101.c may create multiple check points at user defined time intervals or on demand or at the time of shutdown. Further, the transaction handling unit 101.c may use any of the available checkpoints and is ready to process further data.

The transaction handling unit 101.c partitions the work into independent tasks so that the overhead of inter process and inter thread communication is kept at minimal. In an embodiment, transaction handling unit 101.c mines closed sequential patterns without candidate maintenance; data processing of each sequence is completely independent of the other. In another embodiment, the transaction handling unit 101.c may distribute the processing loads on multiple hosts to take advantage of the multiple processors and memory available on the network.

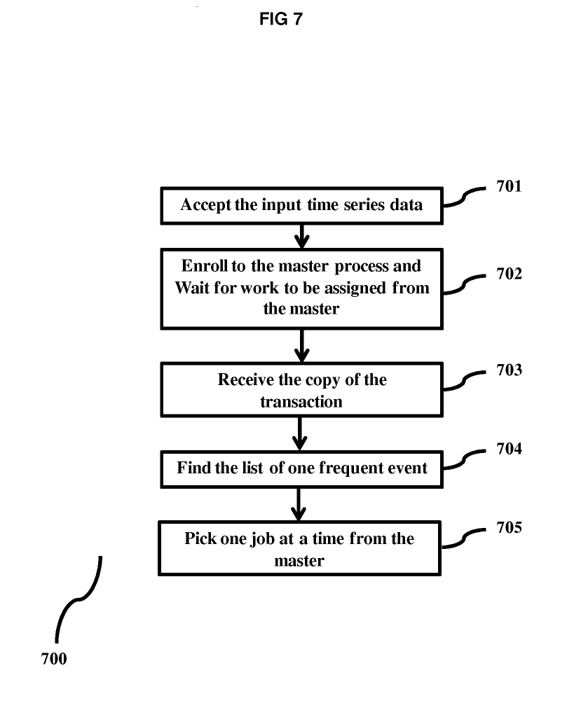

FIG. 7 is a flow diagram, which explains the steps to achieve the highest parallelism according to the embodiments disclosed herein. The highest parallelism may be achieved in coordination by 2 types of processes such as a master process and a plurality of slave processes. The master process is derived from the master server and the slave process from the slave server. Initially, the master process accepts (701) the input time series data and maintains the transactions and then the slave processes running on different hosts on the network enroll (702) to the master process and wait for work to be assigned from the master server. Each slave process receives (703) the copy of the transactions. Further, the master process finds (704) the list of one frequent events (event that meets the minimum support criteria) and creates a global job queue. A new job can be picked up from the global job queue. Once the global job queue is created, it sends one job at a time to each slave server. A job created by the master server is a ‘one sequence’ comprising of one single event that needs to be grown or pruned further. The job includes pruning and timeout settings. The various actions in method 700 may be performed in the order presented, in a different order or simultaneously. Further, in some embodiments, some actions listed in FIG. 7 may be omitted.

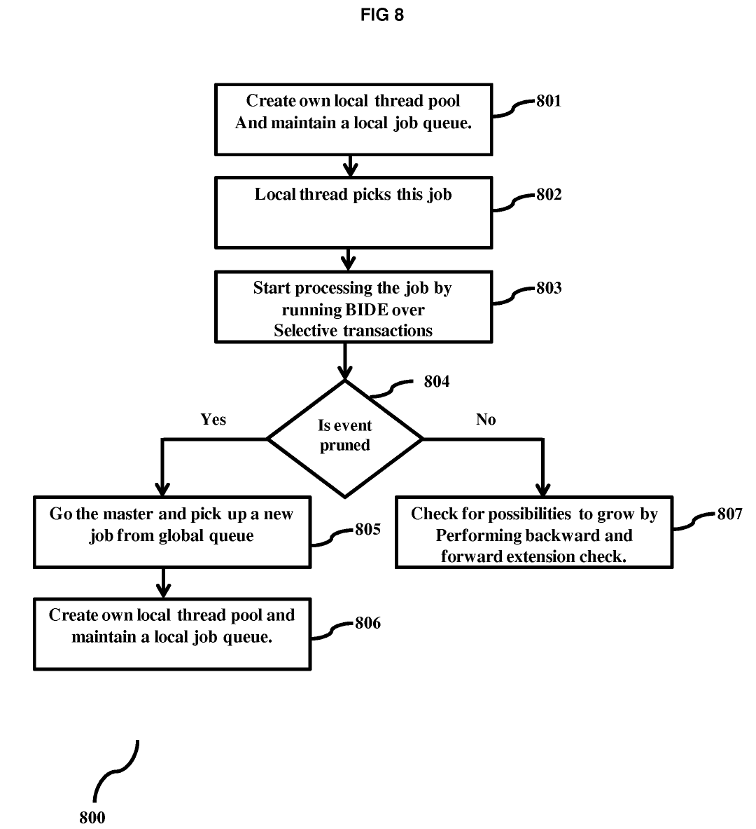

FIG. 8 is a flow diagram, which explains the slave processing of the frequent sequences according to the embodiments disclosed herein. Initially, the slave creates (801) its own local thread pool during initialization of the slave server and maintains a local job queue. The job received from the master is placed in the Local job queue. Further, a local thread from its own thread pool picks (802) the job. The slave starts processing (803) the job by running the transaction handling unit 101.c over selected transactions. A check (804) is performed at each pass to see whether the resultant sequence is pruned using back scan pruning technique. If the sequence is pruned due to its first semi-maximum period, the slave goes to the master, informs the master of the first event in first semi-maximum period of the sequence responsible for pruning, and picks (805) a new job from global queue and adds it to its local job queue. The master process maintains a global list of first event in first semi-maximum periods that are responsible for pruning of job sequences. If the event is not pruned then the slave checks (807) for possibilities to grow by performing backward and forward extension check. If the sequence cannot be grown further, it is marked as a closed sequence and is updated in the global closed sequence data structure maintained by the master. For every such sequence, the slave gathers a set of first semi-maximum periods that are above minimum support threshold. The first event of all such first semi-maximum periods is communicated back to the master that stores the same as ‘events responsible for pruning of job sequences’. Further, once the slave's local job queue is empty; information for all the resultant closed sequences is sent to the master server which also serves to inform the master server of the availability of the slave server to process additional jobs. Eventually, all jobs, from the master process job queue are processed by assigning them to slave servers. Further, the master server scans the global list of events responsible for pruning of job sequences to check whether any of these events does not have any closed sequences. As a result, the master server issues jobs to slave servers to process all events responsible for pruning of job sequences that do not have closed sequences starting with such events. Once all such events are processed, the master server job can be deemed as complete. The various actions in method 800 may be performed in the order presented, in a different order or simultaneously. Further, in some embodiments, some actions listed in FIG. 8 may be omitted.

The embodiments disclosed herein can be implemented through at least one software program running on at least one hardware device and performing network management functions to control the network elements. The network elements shown in FIG. 2 include blocks, which can be at least one of a hardware device, or a combination of hardware device and software module.

The embodiment disclosed herein specifies a system for finding patterns represented by closed sequences with temporal ordering in time series data. The mechanism allows handling incremental data with future and backdated timestamps providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device, which can be programmed including e.g. any kind of computer like a server or a personal computer, or the like, or any combination thereof, e.g. one processor and two FPGAs. The device may also include means, which could be e.g. hardware means like e.g. an ASIC, or a combination of hardware, and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the application may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for processing time series data, said method comprising of
converting said data into a plurality of transactions by a transaction handling unit using a sliding time window of pre-defined length;
finding patterns by processing only selective transactions by said transaction handling unit in said plurality of transactions, wherein said patterns are represented by a plurality of closed sequences with temporal ordering in said data.

2. The method, as claimed in claim 1, wherein said method further comprises of said transaction handling unit distributing said data across a plurality of slave computers, wherein a master-slave topology is employed.

3. The method, as claimed in claim 1, wherein said method further comprises of said transaction handling unit processing said data in a parallel manner, wherein a standalone server topology is employed by utilizing at least one CPU core.

4. The method, as claimed in claim 1, wherein said method further comprises of said transaction handling unit accepting said data and creating said transactions in an incremental manner.

5. The method, as claimed in claim 1, wherein said time series data may further be at least one of backdated data; or appended data.

6. The method, as claimed in claim 1, wherein said method further comprises of said transaction handling unit pruning said plurality of sequences.

7. The method, as claimed in claim 1, wherein said method further comprises of said transaction handling unit extending said plurality of sequences.

8. The method, as claimed in claim 1, wherein said method further comprises of a hibernation and check pointing module storing said plurality of transactions into at least one data structure.

9. The method, as claimed in claim 8, wherein said method further comprises of said hibernation and check pointing module using said stored transactions as a reference for restoration.

10. The method, as claimed in claim 1, wherein said method further comprises of said transaction handling unit finding patterns in a plurality of transactions selected from said plurality of transactions.

11. The method, as claimed in claim 10, wherein said method further comprises of said transaction handling unit finding patterns in an incremental manner.

12. A system for processing time series data, said system comprising of a transaction handling unit, wherein said transaction handling unit is configured for
converting said data into a plurality of transactions using a sliding time window of pre-defined length;
finding patterns by processing only selective transactions in said plurality of transactions, wherein said patterns are represented by a plurality of closed sequences with temporal ordering in said data.

13. The system, as claimed in claim 12, wherein said transaction handling unit is further configured for distributing said data across a plurality of slave computers, wherein a master-slave topology is employed.

14. The system, as claimed in claim 12, wherein said transaction handling unit is further configured for processing said data in a parallel manner, wherein a standalone server topology is employed by utilizing at least one CPU core.

15. The system, as claimed in claim 12, wherein said transaction handling unit is further configured for accepting said data and creating said transactions in an incremental manner.

16. The system, as claimed in claim 12, wherein said transaction handling unit is further configured for pruning said plurality of sequences.

17. The system, as claimed in claim 12, wherein said transaction handling unit is further configured for extending said plurality of sequences.

18. The system, as claimed in claim 12, wherein said system further comprises of a hibernation and check pointing module, wherein said hibernation and check pointing module is configured for storing said plurality of transactions into at least one data structure.

19. The system, as claimed in claim 18, wherein said hibernation and check pointing module is further configured for using said stored transactions as a reference for restoration.

20. The system, as claimed in claim 12, wherein said transaction handling unit is further configured for finding patterns in a plurality of transactions selected from said plurality of transactions.

21. The system, as claimed in claim 20, wherein said transaction handling unit is further configured for finding patterns in an incremental manner.
